(19) United States
(12) Patent Application Publication
(10) Pub. No.: US 2023/0004373 A1
(43) Pub. Date: Jan. 5, 2023

(54) INFORMATION PROCESSING SYSTEM, INFORMATION PROCESSING DEVICE, INFORMATION PROCESSING METHOD, PROGRAM, AND RECORDING MEDIUM

(71) Applicant: TOYOTA JIDOSHA KABUSHIKI KAISHA, Toyota-shi (JP)

(72) Inventors: Masafumi YAMAMOTO, Nagakute-shi (JP); Atsushi TABATA, Okazaki-shi (JP); Koichi OKUDA, Toyota-shi (JP); Yuki MAKINO, Aichi-gun (JP)

(73) Assignee: TOYOTA JIDOSHA KABUSHIKI KAISHA, Toyota-shi (JP)

(21) Appl. No.: 17/663,264

(22) Filed: May 13, 2022

(30) Foreign Application Priority Data
Jul. 2, 2021 (JP) 2021-110757

(51) Int. Cl. G06F 8/65

(52) U.S. Cl. CPC G06F 8/65

(57) ABSTRACT

A software update system according to one embodiment of the present disclosure is a software update system configured to update software used in a vehicle based on update data of the software, the update data being transmitted to the vehicle from a distribution server that is communicably connected to the vehicle. The software update system includes: a notification unit configured to notify, when the update data is present, the presence of the update data to a user of the vehicle, along with information about an effect provided by the software update based on the update data; and an update unit configured to update the software based on the update data, when a predetermined input is accepted from the user after the notification by the notification unit.

### CROSS-REFERENCE TO RELATED APPLICATION

This application claims priority to Japanese Patent Application No. 2021-110757 filed on Jul. 2, 2021, incorporated herein by reference in its entirety.

### BACKGROUND

### 1. Technical Field

The present disclosure relates to an information processing system and the like.

### 2. Description of Related Art

There is known a technique of transmitting update data of software used in a vehicle (for example, update data of programs, parameters used for the programs, etc.,) to the vehicle from an external device to perform update of the software, for example (see Japanese Unexamined Patent Application Publication No. 2020-4245 (JP 2020-4245 A)).

In JP 2020-4245 A, when software is updated, it is determined in advance whether or not successful update of the software is available. When it is determined that the successful update is available, the software is updated. According to the technique, it is possible to enhance the convenience of a user by avoiding the situation where, for example, the user is waiting for completion of software update but the software is not successfully updated and the user ends up wasting time.

### SUMMARY

However, even if successful software update is available, the effect obtained by actual software update may be relatively small in some cases. Accordingly, in the situation where, for example, the user is waiting for software update to be completed, the software update is performed, but the effect of the software update is small enough to disappoint the user, so that the time of the user may be wasted.

In light of the above issue, an object of the present disclosure is to provide a technique capable of enhancing user convenience when software used in a vehicle is updated.

In order to accomplish the object, an embodiment of the present disclosure provides an information processing system configured to update software used in a vehicle based on update data of the software, the update data being transmitted to the vehicle from an external device that is communicably connected to the vehicle. The information processing system includes a notification unit and an update unit. The notification unit is configured to notify, when the update data is present, the presence of the update data to a user of the vehicle, along with information about an effect provided by the software update based on the update data. The update unit is configured to update the software based on the update data, when a predetermined input is accepted from the user after the notification by the notification unit.

Another embodiment of the present disclosure provides an information processing device configured to update software used in a vehicle based on update data of the software, the update data being transmitted to the vehicle from an external device that is communicably connected to the vehicle. The information processing device includes a notification unit and an update unit. The notification unit is configured to notify, when the update data is present, the presence of the update data to a user of the vehicle, along with information about an effect provided by the software update based on the update data. The update unit is configured to update the software based on the update data, when a predetermined input is accepted from the user after the notification by the notification unit.

Still another embodiment of the present disclosure provides an information processing method executed by an information processing device configured to update software used in a vehicle based on update data of the software, the update data being transmitted to the vehicle from an external device that is communicably connected to the vehicle. The information processing method includes: a notification step of notifying, when the update data is present, the presence of the update data to a user of the vehicle, along with information about an effect provided by the software update based on the update data; and an update step of updating the software based on the update data, when a predetermined input is accepted from the user after the notification in the notification step.

Yet another embodiment of the present disclosure provides a program for causing an information processing device to execute steps, the information processing device being configured to update software used in a vehicle based on update data of the software, the update data being transmitted to the vehicle from an external device that is communicably connected to the vehicle. The steps include: a notification step of notifying, when the update data is present, the presence of the update data to a user of the vehicle, along with information about an effect provided by the software update based on the update data; and an update step of updating the software based on the update data, when a predetermined input is accepted from the user after the notification in the notification step.

A further embodiment of the present disclosure provides a computer-readable recording medium that stores the program.

The embodiments can enhance the user convenience in update of the software used in a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing an example of a software update system;

FIG. 2 shows an example of the hardware configuration of a vehicle;

FIG. 3 shows an example of the hardware configuration of a distribution server;

FIG. 4 is a functional block diagram showing an example of the functional configuration of the software update system;

FIG. 5 shows an example of the update of a shift map for a transmission of the vehicle;

FIG. 6 shows an example of the update of a switching map of motors of the vehicle;

FIG. 7 shows an example of the results of a virtual simulation regarding secular change in the state of the vehicle during shift change of the transmission before and after update of a control logic relating to a shift change (upshift) of the transmission of the vehicle;

FIG. 8 shows another example of the results of the virtual simulation regarding secular change in the state of the vehicle during shift change of the transmission before and after update of the control logic relating to shift change (upshift) of the transmission of the vehicle;

FIG. 9 is a flowchart schematically showing an example of software update processing by the distribution server; and

FIG. 10 is a flowchart schematically showing an example of software update processing by a central ECU.

### DETAILED DESCRIPTION OF EMBODIMENTS

Hereinafter, embodiments will be described with reference to the drawings.

Outline of Software Update System

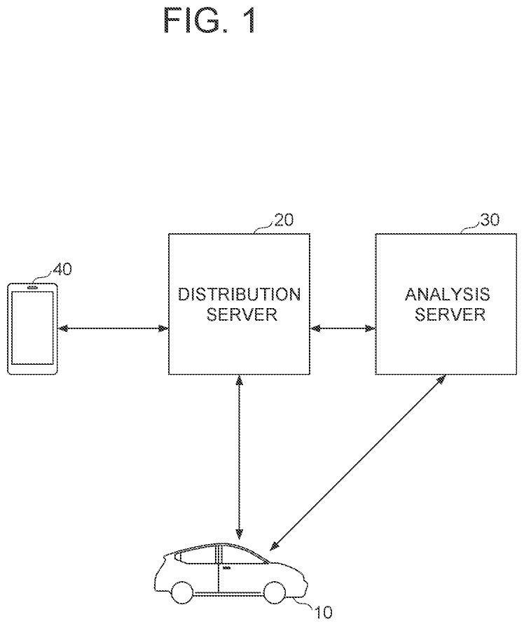

With reference to FIG. 1, the outline of a software update system 1 according to the present embodiment will be described.

FIG. 1 is a schematic view showing an example of the software update system 1.

As shown in FIG. 1, the software update system 1 (an example of the information processing system) includes a vehicle 10, a distribution server 20, an analysis server 30, and a user terminal 40.

The software update system 1 distributes update data of software used in the vehicle 10 to the vehicle 10, and allows update of software of the vehicle 10.

The software of the vehicle 10 includes, for example, programs that are executed on computers (in-vehicle computers) mounted on the vehicle 10, such as a gateway electronic control unit (ECU) 12, an ECU 13, and a central ECU 19 as will be described later. The software of the vehicle 10 includes various data, such as parameters used in processing by the programs that are executed on the in-vehicle computers, for example.

The vehicle 10 is a software update target. For example, the vehicle 10 travels with motive power transmitted from a given motor, such as an engine or a motor generator, to a drive wheel through a drive system such as a transmission, a differential, and a drive shaft.

The vehicle 10 is mounted with a communication device 11 as will be described later. The vehicle 10 is communicably connected to external devices, such as the distribution server 20 and the analysis server 30, via a predetermined communication line, for example. This enables the vehicle 10 to transmit information signals to the distribution server 20 or the analysis server 30, and to receive control signals and information signals (e.g., software update data) from the distribution server 20 or the analysis server 30.

The predetermined communication line includes, for example, a mobile communication network that is terminated by a base station, a satellite communication network that uses communication satellites, and a wide area network (WAN) such as the Internet network. The predetermined communication line may also include, for example, a local area network (LAN) of a facility where the distribution server 20 or the analysis server 30 is installed. The predetermined communication line may also include, for example, a short-range communication line based on wireless communication standards such as WiFi and Bluetooth (registered trademark). The same may also apply to a communication line used for communication between the distribution server 20 and the analysis server 30, a communication line used for communication between the distribution server 20 and the user terminal 40, and other communication lines.

The software update system 1 may include one or more vehicles 10. In the latter case, the software update system 1 may include the vehicles 10 of the same vehicle type or the vehicles 10 of two or more vehicle types.

The distribution server 20 (an example of the information processing device and the external device) distributes various data used in the vehicle 10 to the vehicle 10. Specifically, the distribution server 20 distributes software update data to the vehicle 10.

For example, the distribution server 20 is an on-premise server or a cloud server installed in a monitoring center, or the like, that provides centralized monitoring of the states of the vehicles 10. For example, the distribution server 20 may also be an edge server installed in an area where the vehicles 10 mainly travel (for example, the area where the vehicles 10 are legally registered). In this case, two or more distribution servers 20 may be provided for all the vehicles 10 included in the software update system 1. The same may apply to the analysis server 30.

As described above, the distribution server 20 is communicably connected to the vehicle 10 via the predetermined communication line. This allows the distribution server 20 to receive various information signals from the vehicle 10 and to transmit various information signals (e.g., software update data) and control signals (e.g., software update commands) to the vehicle 10.

The analysis server 30 acquires, for example, various data (hereinafter “vehicle data”) representing the state of the vehicle 10 and performs analysis on the vehicle 10. Specifically, the analysis server 30 analyzes an effect obtained by updating the software of the vehicle 10.

As described above, the analysis server 30 is communicably connected to the vehicle 10 via the predetermined communication line. This allows the analysis server 30 to receive various information signals (e.g., vehicle data) from the vehicle 10 and to transmit various information signals or control signals to the vehicle 10.

The analysis server 30 is communicably connected to the distribution server 20 or the user terminal 40 via the predetermined communication line. This enables the analysis server 30 to transmit various information signals and control signals to the distribution server 20 or the user terminal 40, and to receive various information signals and control signals from the distribution server 20 or the user terminal 40.

Note that the functions of the distribution server 20 and the analysis server 30 may be implemented by collecting the functions into a single server (an example of the information processing device), or be implemented by distributing the functions over three or more servers.

The user terminal 40 is a terminal device that is used (possessed) by the user of the vehicle 10. For example, the user of the vehicle 10 is the owner of the vehicle 10 or a family member of the owner of the vehicle 10. The user terminal 40 is a mobile (portable) terminal device, such as a smartphone, a tablet terminal, or a laptop-style personal computer (PC). The user terminal 40 may also be a stationary terminal device such as a desktop-style PC, for example.

As described above, the user terminal 40 is communicably connected to the distribution server 20 via the predetermined communication line. This enables the user terminal 40 to receive control signals and information signals transmitted from the distribution server 20, and to make the user of the vehicle 10 notice the information included in the signals through a display or a speaker. In response to an input from the user, the user terminal 40 can also transmit control signals and information signals appropriate to the content of the input to the distribution server so as to inform the request of the user corresponding to the content of the input made by the user to the distribution server 20.

Hardware Configuration of Software Update System

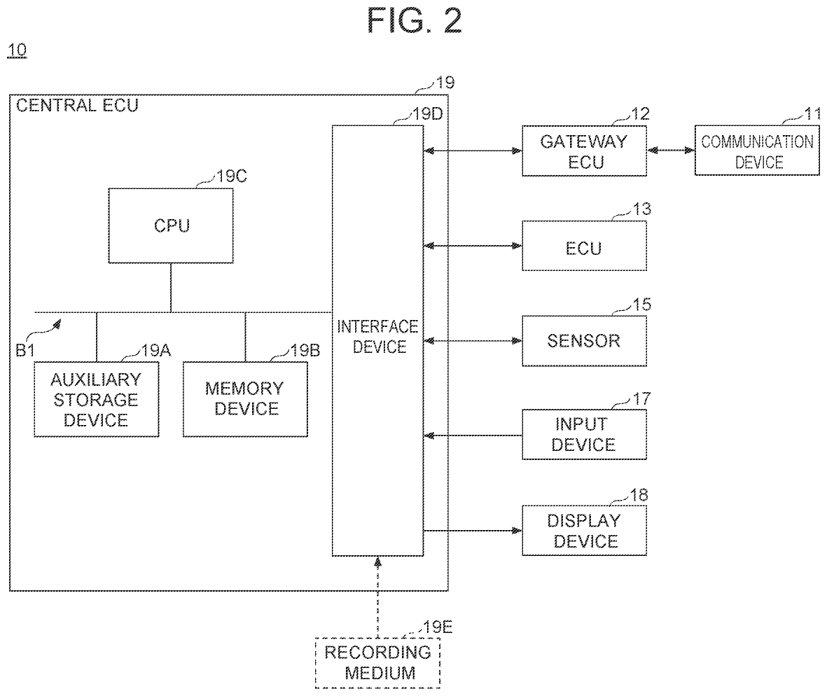

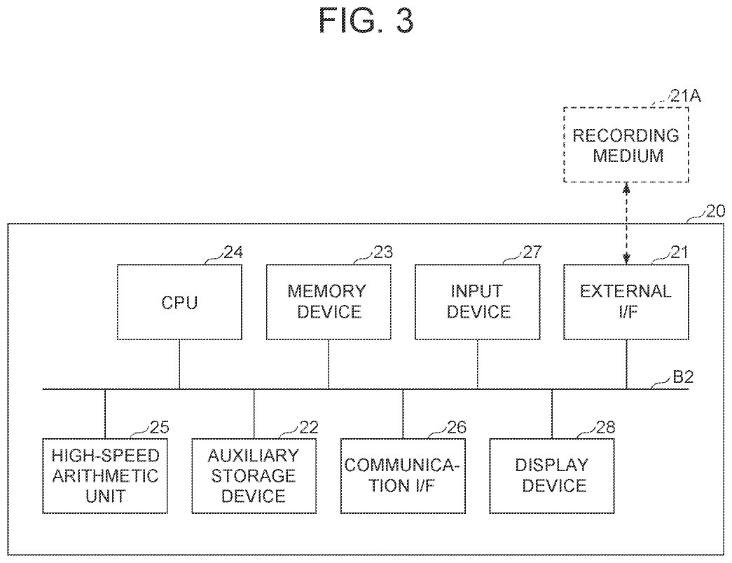

Now, with reference to FIGS. 2 and 3 in addition to FIG. 1, the hardware configuration of the software update system 1 will be described.

Hardware Configuration of Vehicle

FIG. 2 shows an example of the hardware configuration of the vehicle 10.

As shown in FIG. 2, the vehicle 10 includes the communication device 11, the gateway ECU 12, the ECU 13, a sensor 15, an input device 17, a display device 18, and the central ECU 19.

The communication device 11 communicates with the outside of the vehicle 10 through a predetermined communication line. For example, the communication device 11 is a mobile communication module capable of connecting to a mobile communication network that is terminated by a base station to communicate with the outside. Specifically, the communication device 11 may be a data communication module (DCM). The communication device 11 is communicably connected to the gateway ECU 12, the ECU 13, the central ECU 19, and the like, via a communication line inside the vehicle 10. For example, the communication line inside the vehicle 10 is a one-to-one communication line or an in-vehicle network. Examples of the in-vehicle network include a controller area network (CAN), a local interconnect network (LIN), FlexRay, and an in-vehicle Ethernet. The communication device 11 may transmit given signals to the outside in response to commands (requests) from the gateway ECU 12, for example. The signals received by the communication device 11 from the outside are also taken into the gateway ECU 12.

The gateway ECU 12 functions as a gateway between the communication line outside the vehicle 10 and the communication line inside the vehicle 10 (e.g., in-vehicle network).

The functions of the gateway ECU 12 may be implemented by any hardware, or by a combination of any hardware and software. For example, the gateway ECU 12 may have a hardware configuration similar to that of the central ECU 19 as will be described later. The gateway ECU 12 may implement various functions by loading programs installed on an auxiliary storage device into a memory device and executing the programs on a central processing unit (CPU). The same may also apply to the ECU 13.

For example, the gateway ECU 12 uses a known method to authenticate that the signal received by the communication device 11 from the outside is a signal that is transmitted from a regular transmission source and that is untampered. The regular transmission source means a transmission source that is registered as a transmission source in advance (e.g., distribution server 20, analysis server 30, etc.), or a transmission source that is authenticated in advance through mutual communication. The gateway ECU 12 transmits only the data of a successfully authenticated signal, among the signals received by the communication device 11, to predetermined in-vehicle devices (e.g., ECU 13, central ECU 19, etc.) via the communication line inside the vehicle 10.

For example, the gateway ECU 12 generates signals including the contents such as predetermined information and commands (requests), as requested by various devices of the vehicle 10, and transmits the signals through the communication device 11 to given destinations (e.g., distribution server 20 or analysis server 30).

One or more ECUs 13 are mounted on the vehicle 10. The ECUs 13 perform control relating to various functions of the vehicle 10. For example, the ECUs 13 include the ECU 13 that controls an engine as a motive power source of the vehicle 10, the ECU 13 that controls a motor generator (MG) as a motive power source of the vehicle 10, and the ECU 13 that controls a shift position of the transmission of the vehicle 10.

One or more sensors 15 are mounted on the vehicle 10. The sensor or sensors 15 output measurement data on the state of the vehicle 10. Output (measured data) from the sensor 15 is taken into the central ECU 19 via the communication line inside the vehicle 10. For example, the sensors 15 include the sensor 15 (wheel speed sensor) that measures wheel speed of each wheel of the vehicle 10. For example, the sensors 15 also include the sensors 15 (acceleration sensors) that measure longitudinal acceleration, lateral acceleration and vertical acceleration of the vehicle 10. For example, the sensors 15 also include the sensors 15 (temperature sensors) that measure the temperature at given locations of the vehicle 10. Examples of the temperature sensors include temperature sensors that measure the temperature of a battery for driving or batteries for auxiliary machines mounted on the vehicle 10, coolant temperature sensors that measure the temperature of coolant for various devices, and oil temperature sensors that measure the temperature of lubricants in various devices. Examples of the sensors 15 also include a sensor 15 (global navigation satellite system (GNSS) sensor) that measures the position of the vehicle 10.

The input device 17 is provided in the cabin of the vehicle 10 and accepts various inputs from occupants. The input device 17 includes an operation input device, such as buttons, toggles, levers, a touch panel, or a touch pad, which accept operation inputs from the occupants, for example. The input device 17 also includes a voice input device, such as a microphone that accepts voice input from the occupants of the vehicle 10, for example. The input device 17 also includes a gesture input device that accepts gesture input from the occupants of the vehicle 10, such as a camera capable of imaging occupants in the cabin of the vehicle 10. Input signals representing the contents of the inputs accepted in the input device 17 are taken into the central ECU 19 via the communication line inside the vehicle 10.

The display device 18, which is provided at a location that is easily viewed from the driver's seat in the cabin of the vehicle 10, displays various information screens. For example, the display device 18 is a liquid crystal display, an organic electroluminescence (EL) display, or the like. The display device 18 is communicably connected to the central ECU 19 through the communication line inside the vehicle 10. The central ECU 19 can output control signals to the display device 18 to control the display device 18 to display predetermined information screens.

For example, the central ECU 19 acts as a superordinate control device of various ECUs including the gateway ECU 12 and the ECU 13 mounted on the vehicle 10, to perform comprehensive control of the operation of various ECUs and function as a place to store various data used in the various ECUs.

The functions of the central ECU 19 may be implemented by any hardware, or by a combination of any hardware and software. For example, as shown in FIG. 2, the central ECU 19 includes an auxiliary storage device 19A, a memory device 19B, a CPU 19C, and an interface device 19D which are connected through a bus B1.

The auxiliary storage device 19A is a nonvolatile storage device that stores programs to be installed and stores required files, data, and the like. For example, the auxiliary storage device 19A is a flash memory or the like.

For example, when there is an instruction to start a program, the memory device 19B loads the program stored in the auxiliary storage device 19A to allow the CPU 19C to read the program. The memory device 19B is a static random-access memory (SRAM), for example.

The CPU 19C executes the program loaded to the memory device 19B, and implements various functions of the central ECU 19 in response to commands of the program, for example.

The interface device 19D is used, for example, as an interface for connecting to the communication line inside the vehicle 10. The interface device 19D may include a plurality of different types of interface devices depending on the type of the communication line to be connected.

The programs that implement various functions of the central ECU 19 are provided by a portable recording medium 19E, for example. In this case, the interface device 19D functions as an interface for reading data from the recording medium 19E and writing data to the recording medium 19E. The recording medium 19E is a special tool that is connected through a detachable cable to an external connection connector such as a data link coupler (DLC), for example. The recording medium 19E may be, for example, an SD memory card or a universal serial bus (USB) memory. The programs may be downloaded from another computer (e.g., distribution server 20) outside the vehicle 10 through a predetermined communication line, and be installed on the auxiliary storage device 19A.

Hardware Configuration of Distribution Server

FIG. 3 shows an example of the hardware configuration of the distribution server 20.

The functions of the distribution server 20 may be implemented by any hardware, or by a combination of any hardware and software. For example, as shown in FIG. 3, the distribution server 20 includes an external interface 21, an auxiliary storage device 22, a memory device 23, a CPU 24, a communication interface 26, an input device 27, and a display device 28, which are connected through a bus B2.

Here, the analysis server 30 and the user terminal 40 may also have the same hardware configuration as the distribution server 20. Hereinafter, illustration and description of the hardware configuration of the analysis server 30 and the user terminal 40 are omitted.

The external interface 21 functions as an interface for reading data from a recording medium 21A and writing data to the recording medium 21A. The recording medium 21A includes flexible disks, a compact disc (CD), a digital versatile disc (DVD), a Blu-ray (registered trademark) disc (BD), SD memory cards, and universal serial bus (USB) memory. This allows the distribution server 20 to read various data used for processing through the recording medium 21A, store the data in the auxiliary storage device 22, and install programs that implement various functions.

The distribution server 20 may acquire various data and programs from external devices through the communication interface 26.

The auxiliary storage device 22 stores installed various programs and stores files, data, and the like, required for various processing. The auxiliary storage device 22 includes a hard disk drive (HDD), a solid-state drive (SSD), and a flash memory, for example.

When there is an instruction to start a program, the memory device 23 reads the program from the auxiliary storage device 22 and store the read program. The memory device 23 includes, for example, dynamic random-access memory (DRAM) and static random-access memory (SRAM).

The CPU 24 executes the various programs loaded from the auxiliary storage device 22 to the memory device 23, and implements the various functions of the distribution server 20 based on the programs.

A high-speed arithmetic unit 25 performs arithmetic processing at relatively high speeds in cooperation with the CPU 24. The high-speed arithmetic unit 25 includes, for example, a graphics processing unit (GPU), an application specific integrated circuit (ASIC), and a field-programmable gate array (FPGA).

The high-speed arithmetic unit 25 may be omitted depending on the speed of required processing.

The communication interface 26 is used as an interface for establishing a connection with external devices in a communicable way. This allows the distribution server 20 to communicate with external devices, such as the vehicle 10, the analysis server 30, and the user terminal 40, through the communication interface 26, for example. The communication interface 26 may also have a plurality of types of communication interfaces depending on the communication scheme, or the like, used for communication with devices to be connected.

The input device 27 accepts various inputs from a user.

The input device 27 includes, for example, an operation input device that accepts mechanical operation input from the user. The operation input device includes buttons, toggles, and levers, for example. The operation input device includes, for example, a touch panel mounted on the display device 28 and a touch pad provided separately from the display device 28.

The input device 27 also includes, for example, a voice input device that can accept voice input from the user. The voice input device includes, for example, a microphone capable of collecting the voice of the user.

The input device 27 also includes, for example, a gesture input device that can accept input of gesture from the user. The gesture input device includes, for example, a camera that can image the user's gestures.

The input device 27 also includes, for example, a biometric input device that can accept a biometric input from the user. For example, the biometric input device includes a camera capable of acquiring image data that contains information about a user's fingerprint and iris.

The display device 28 displays information screens and operation screens to the user. For example, the display device 28 includes a liquid crystal display, an organic electroluminescence (EL) display, or the like.

Functional Configuration of Software Update System

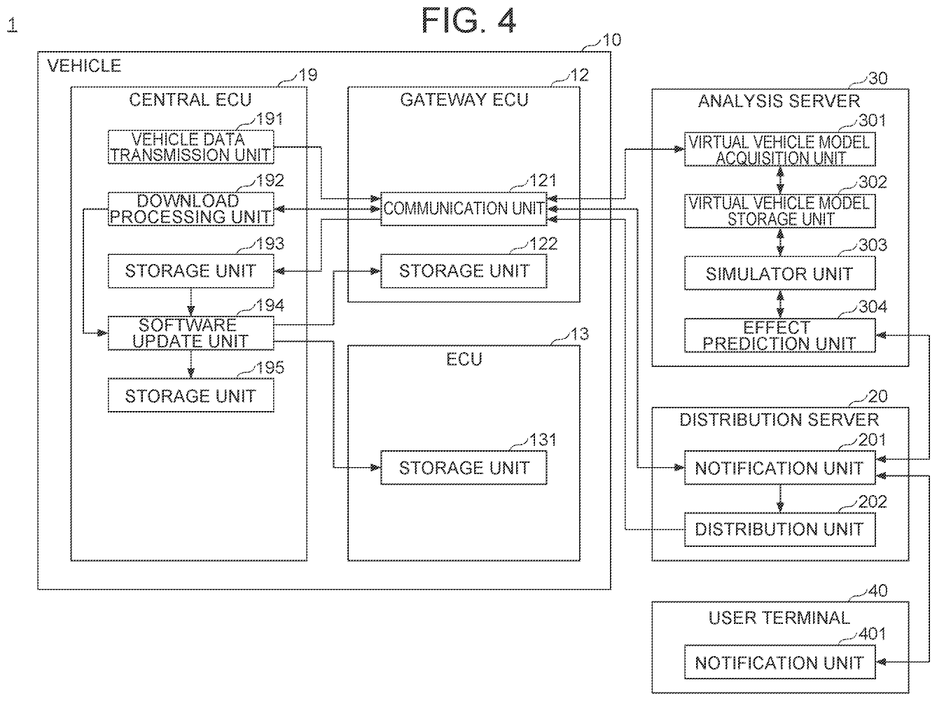

Now, the functional configuration of the software update system 1 will be described with reference to FIG. 4 in addition to FIGS. 1 to 3.

FIG. 4 is a functional block diagram showing an example of the functional configuration of the software update system 1.

Functional Configuration of Vehicle

As shown in FIG. 4, the gateway ECU 12 includes a communication unit 121 and a storage unit 122 as functional units. The function of the communication unit 121 may be implemented by, for example, loading a program that is installed on the auxiliary storage device of the gateway ECU 12 into a memory device and executing the loaded program on the CPU. The function of the storage unit 122 may be implemented by, for example, a storage area defined in the auxiliary storage device, or the like, of the gateway ECU 12.

The communication unit 121 controls the communication device 11 to take signals received from the outside of the vehicle 10 into the gateway ECU 12 and to transmit signals to the outside of the vehicle 10.

The storage unit 122 stores various data used in the gateway ECU 12. In the storage unit 122, data on various programs installed on the gateway ECU 12 (auxiliary storage device) is registered (stored), for example. In the storage unit 122, data on parameters referenced in the processing based on various programs of the gateway ECU 12 is registered (stored), for example.

The ECU 13 includes a storage unit 131 as a functional unit. The function of the storage unit 131 is implemented by, for example, a storage area defined in the auxiliary storage device of the ECU 13.

The storage unit 131 stores various data used in the ECU 13. In the storage unit 131, data for various programs installed on the ECU 13 (auxiliary storage device) is registered (stored), for example. In the storage unit 131, data on parameters referenced in the processing based on various programs of the ECU 13 is registered (stored), for example.

The central ECU 19 includes a vehicle data transmission unit 191, a download processing unit 192, a storage unit 193, a software update unit 194, and a storage unit 195 as functional units. The functions of the vehicle data transmission unit 191, the download processing unit 192, and the software update unit 194 may be implemented by loading programs to be installed on the auxiliary storage device 19A into the memory device 19B and executing the loaded programs on the CPU 19C, for example. The functions of the storage units 193, 195 may be implemented by, for example, storage areas defined in the auxiliary storage device 19A.

The vehicle data transmission unit 191 acquires vehicle data representing the state of the vehicle 10, and transmits (uploads) the data to the analysis server 30 via the gateway ECU 12 (communication device 11) at each predetermined period. For example, the vehicle data transmission unit 191 may upload the acquired vehicle data to the analysis server 30 in real time, or may accumulate the acquired vehicle data in the memory device 19B or the auxiliary storage device 19A, and transmit the accumulated vehicle data collectively to the analysis server 30 at predetermined timing. The vehicle data to be transmitted includes, for example, measurement data output from the sensors 15. The vehicle data to be transmitted also includes, for example, control data including command values output from various ECUs, such as the gateway ECU 12, the ECU 13, and the central ECU 19, and values as a result of arithmetic operations in the process of control processing.

The download processing unit 192 performs processing regarding download of software update from the distribution server 20.

The storage unit 193 stores software update data downloaded from the distribution server 20.

The software update unit 194 updates the software used in the gateway ECU 12, the ECU 13, the central ECU 19, and the like by using the software update data downloaded to the storage unit 193.

The storage unit 195 stores various data used in the central ECU 19. In the storage unit 195, data for various programs installed on the central ECU 19 (auxiliary storage device) is registered (stored), for example. In the storage unit 195, data on parameters referenced in the processing based on various programs of the central ECU 19 is also registered (stored), for example.

Functional Configuration of Distribution Server

As shown in FIG. 4, the distribution server 20 includes a notification unit 201 and a distribution unit 202 as functional units. The functions of the notification unit 201 and the distribution unit 202 may be implemented by, for example, loading programs that are installed on the auxiliary storage device 22 to the memory device 23 and executing the loaded programs on the CPU 24.

When there is software update data available in the vehicle 10, the notification unit 201 notifies the presence of the software update to the vehicle 10. When the software update system 1 includes two or more vehicles 10, the presence of the software update data is notified to, out of all the vehicles 10, only the users of the vehicles 10 that are the targets of software update with the software update data. For example, when the vehicles 10 include the vehicles 10 of two or more vehicle types, the presence or absence of software update or the content of the update may be different for each vehicle type. Even when, for example, all the vehicles 10 are of the same vehicle type, there may be difference in presence or absence of software update or the content of the update, depending on the grade. Moreover, for example, depending on the terms of agreement between users and a service provider regarding the software update of the vehicle 10, the service available for the users may be different, that is, the service provided to the users may be different according to the amount of price (fees), and this may result in difference in the content of software update.

Specifically, the notification unit 201 transmits to the analysis server 30 a signal for requesting prediction of the effect of software update on the vehicle 10 that is a distribution target of update data. In this case, when there are more than one vehicle 10 as the distribution target of the update data, the notification unit 201 requests the analysis server 30 to predict the effect of the software update on each of the vehicles 10. When the data about the result of prediction of the effect of software update is received from the analysis server 30, the notification unit 201 transmits to the vehicle 10 or the vehicles 10 a signal that notifies the presence of software update data, including the content of the result of predicting the effect of the software update. This allows the central ECU 19 (download processing unit 192) of the vehicle 10 to notify, via the display device 18, the presence of the software update data, along with the result of predicting the effect of the software update. The notification unit 201 may also transmit a signal that notifies the presence of software update data, including the content of the result of predicting the effect of the software update, to the user terminal 40 of the user of the vehicle 10 in place of or in addition to the vehicle 10. This allows the user terminal 40 (notification unit 401) to notify, via the display device, the presence of the software update data to the user of the vehicle 10, along with the result of predicting the effect of the software update. When the user needs to pay the price (fee) of the software update, the notification unit 201 may transmit a signal notifying the presence of software update data, including the content of the result of predicting the effect of the software update and the amount of price, to the vehicle 10 or the user terminal 40. This allows the central ECU 19 (download processing unit 192) of the vehicle 10 to notify, via the display device 18, the presence of the software update data to the user of the vehicle 10, along with the amount of price needed for the software update. The user terminal 40 (notification unit 401) can also notify, via the display device, the presence of the software update data to the user of the vehicle 10, along with the amount of price needed for the software update.

Note that the notification unit 201 may transmit a signal notifying the presence of software update data, including data on the effect that is prepared in advance, to the vehicle 10 without having the analysis server 30 predict the effect. For example, the data on the effect that is prepared in advance is verification data of the effect obtained by experiments or simulation during a development phase of software update data, or data on an actual effect of the vehicle 10 predicted from the validation data.

The distribution unit 202 distributes the software update data to the vehicle 10. For example, when an update permission signal is received from the vehicle 10 or the user terminal 40, the notification unit 201 transmits an update data distribution command to the distribution unit 202, and the distribution unit 202 transmits the update data to the target vehicle 10 in response to the distribution command.

Functional Configuration of Analysis Server

As shown in FIG. 4, the analysis server 30 includes a virtual vehicle model acquisition unit 301, a virtual vehicle model storage unit 302, a simulator unit 303, and an effect prediction unit 304 as functional units. The functions of the virtual vehicle model acquisition unit 301, the simulator unit 303, and the effect prediction unit 304 may be implemented by, for example, loading programs that are installed on an auxiliary storage device of the analysis server 30 to a memory device and executing the loaded programs on a CPU. The function of the virtual vehicle model storage unit 302 is implemented by, for example, a storage area defined in the auxiliary storage device of the analysis server 30.

The virtual vehicle model acquisition unit 301 (an example of the generation unit) acquires a virtual model corresponding to the vehicle 10 (hereinafter referred to as “virtual vehicle model”). The virtual vehicle model is a model that reproduces various features of the vehicle 10 on virtual space. The virtual vehicle model may be a full vehicle model that reproduces various features of the entire vehicle 10, or a partial vehicle model that reproduces only some features of the vehicle 10 which are targets of effect prediction as will be described later. The virtual vehicle model may also be a three-dimensional model that reproduces some or all the shapes of the vehicle 10.

For example, the virtual vehicle model acquisition unit 301 acquires as a virtual vehicle model a general-purpose virtual model (an example of the general-purpose model) that is used for the vehicles 10 having the same vehicle type or having the same vehicle type and the same grade. For example, the general-purpose virtual vehicle model may be a full vehicle model or a partial vehicle model having vehicle type and grade of final specifications corresponding to the pertinent vehicle 10, which is created during the development phase of the vehicle type corresponding to the vehicles 10.

For example, the virtual vehicle model acquisition unit 301 may also acquire the virtual vehicle model by generating a dedicated virtual model (an example of the dedicated model) for each vehicle 10. Specifically, the virtual vehicle model acquisition unit 301 may generate the virtual vehicle model dedicated to the vehicle 10 by appropriately updating the general-purpose virtual vehicle model, with use of the vehicle data uploaded from the corresponding vehicle 10. This allows the virtual vehicle model acquisition unit 301 to generate (update) the virtual vehicle model in matching with at least one of secular change of the vehicle 10, change in use condition of the vehicle 10, and change in component members of the vehicle 10. Therefore, the virtual vehicle model dedicated to the vehicle 10 can reflect the secular change of the vehicle 10, the change in use condition of the vehicle 10, or the change in component members of the vehicle 10. The use condition of the vehicle 10 may include, for example, a condition relating to environments under which the vehicle 10 is used, a travel condition when the vehicle 10 is used, and a condition relating to frequency of use of the vehicle 10. The change in component members of the vehicle 10 may include, for example, change in hardware of the components or the like of the vehicle 10, change in software of the vehicle 10, and change in type of coolant and lubricants used in the vehicle 10. The virtual vehicle model acquisition unit 301 may also generate a digital twin as a dedicated model corresponding to the vehicle 10 by updating the virtual vehicle model in real time based on the vehicle data that is sequentially uploaded from the vehicle 10.

The virtual vehicle model storage unit 302 stores the virtual vehicle model acquired (generated) by the virtual vehicle model acquisition unit 301. When the software update system 1 includes more than one vehicle, virtual vehicle models for the respective vehicles 10 are stored. However, when the general-purpose virtual vehicle model is acquired as the virtual vehicle model as described above, the general-purpose virtual vehicle model that is common to some or all of the vehicles 10 may be stored in the virtual vehicle model storage unit 302 as the virtual vehicle model.

The simulator unit 303 performs virtual simulation relating to the vehicle 10 using the virtual vehicle model of the vehicle 10 that is registered (stored) in the virtual vehicle model storage unit 302. The virtual simulation relating to the vehicle 10 includes a travel simulation of the vehicle 10 under a predetermined travel condition.

The effect prediction unit 304 (an example of the prediction unit) predicts the effect obtained by updating the software used in the vehicle 10 in response to a request from the distribution server 20.

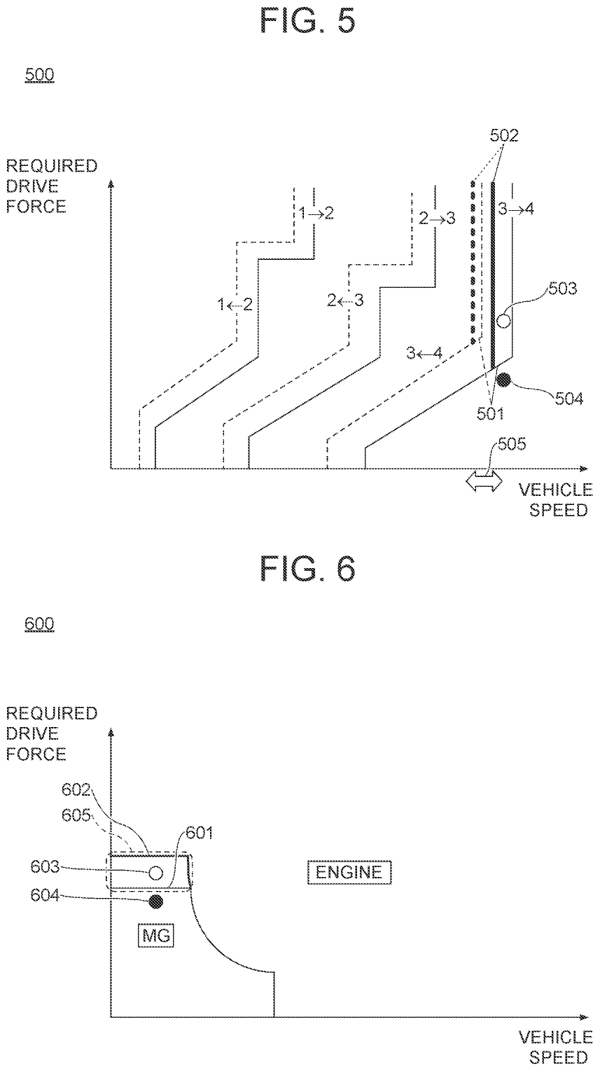

For example, the effect prediction unit 304 predicts the effect by updating the software that is an update target, based on the content of the software update and the history of vehicle data on the vehicle 10 that is a target of software update (see FIGS. 5 and 6 described later). Specifically, the effect of the software update is predicted by determining how well the travel condition and the condition regarding use environment of the vehicle 10, which change with the software update, are compatible with an actual use state of the vehicle 10 that is recognized based on the vehicle data on the vehicle 10. This is because the actual use state of the vehicle 10 changes the frequency that the travel condition and the use environment condition, which are influenced by the software update, are established.

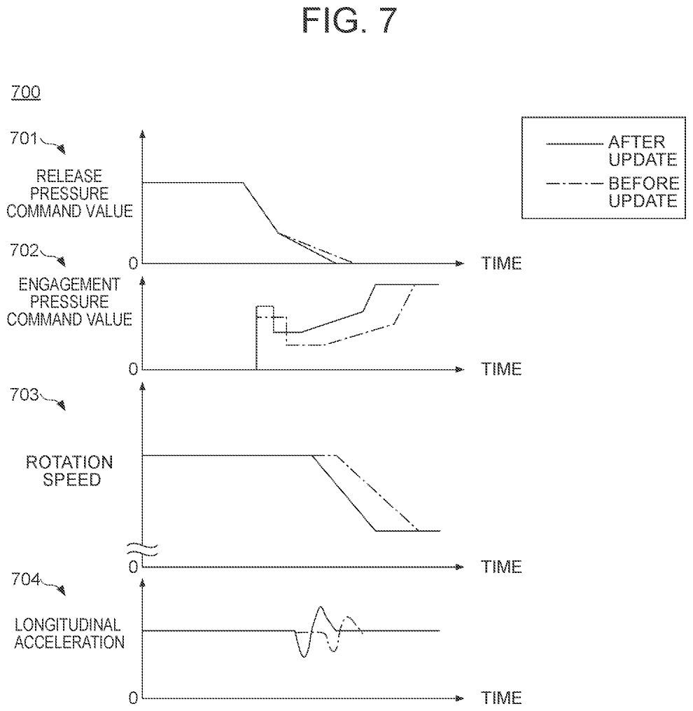

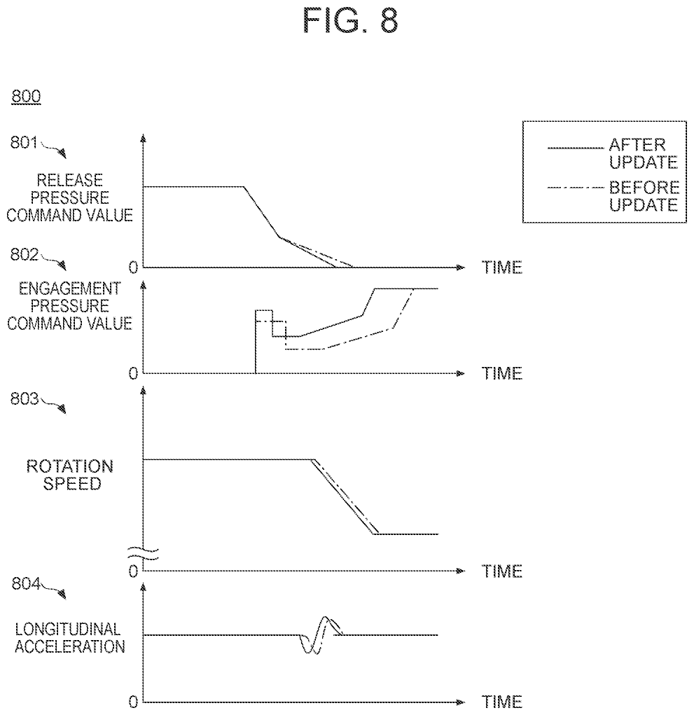

The effect prediction unit 304 may predict the effect of the software update by causing the simulator unit 303 to perform a virtual simulation regarding the vehicle 10 with use of the virtual vehicle model of the vehicle 10 (see FIGS. 7 and 8 described later). Specifically, the virtual vehicle model acquisition unit 301 generates, in response to an instruction from the effect prediction unit 304, a virtual vehicle model corresponding to the case where the software update is performed, based on the latest virtual vehicle model of the vehicle 10. The simulator unit 303 also performs, in response to an instruction from the effect prediction unit 304, a virtual simulation regarding traveling of the vehicle 10 under a predetermined travel condition using a virtual vehicle model corresponding to the vehicle 10 after software update. The predetermined travel condition under which the virtual simulation of the vehicle 10 is performed is variable depending on the content of the software update. The effect prediction unit 304 predicts the effect of the software update based on the result of the virtual simulation using the virtual vehicle model corresponding to the vehicle 10 after the software update. For example, the effect prediction unit 304 predicts the effect of the software update by comparing vehicle data that is acquired in an actual vehicle 10 and uploaded from the vehicle 10 and the data resulting from virtual simulation corresponding to vehicle data on the vehicle 10 after update. As a result, the effect prediction unit 304 can predict the effect of the software update in a relatively simple method on the premise that the existing vehicle data on the vehicle 10 stored in the analysis server 30 is the data on the state of the vehicle 10 before update. The effect prediction unit 304 may also predict the effect of the software update by comparing the results of virtual simulation using the virtual vehicle models corresponding to the vehicle 10 before and after software update. In this case, the effect prediction unit 304 causes the simulator unit 303 to perform a virtual simulation using the virtual vehicle model corresponding to the vehicle 10 after update and a virtual simulation using the virtual vehicle model corresponding to the vehicle 10 before update, under the same conditions. Accordingly, the effect prediction unit 304 can approximately match the travel conditions or other conditions that are prerequisites of the data to be compared. Therefore, the effect prediction unit 304 can predict the effect with a higher accuracy.

The effect prediction unit 304 may predict the presence or absence of the effect depending on, for example, whether or not an index value improved by software update exceeds a predetermined criterion. The effect prediction unit 304 may also predict the degree of the effect based on an index value improved by the software update.

The effect prediction unit 304 may also choose a method of predicting the effect depending on the content of the software update. Specifically, at the time of predicting the effect obtained by software update, the effect prediction unit 304 may determine whether or not to perform a virtual simulation based on the virtual vehicle model corresponding to the vehicle 10 in accordance with the content of the software update. Whether or not to perform the virtual simulation may be prescribed in advance for each piece of the update data, and be determined automatically in accordance with the prescribed content. Whether or not to perform the virtual simulation may be determined using table information or the like, based on the content of the updated data and items of the effect obtained by the software update or the like.

The effect prediction unit 304 may also predict the degree of effect in consideration of a period of time that the user uses the vehicle 10 in the future, for example. The effect prediction unit 304 may predict the period of time that the user uses the vehicle 10 in the future with reference to data such as the timing of registering the vehicle 10 as a new car and the timing of the latest vehicle inspection. For example, in the case where the user is planning to replace the current vehicle 10 at a relatively close time, the user can be benefited from execution of software update for only a short time, and therefore the effect of the software update may substantially be reduced. Specifically, the effect prediction unit 304 may set such that as the period of time the user uses the vehicle 10 in the future is shorter, a criterion for determining that the software update is effective or a criterion for prescribing the degree of the effect is relatively higher. The effect prediction unit 304 may also predict that the software update is not effective when the period of time that the user uses the vehicle 10 in the future is less than a predetermined criterion.

Functional Configuration of User Terminal

As shown in FIG. 4, the user terminal 40 includes a notification unit 401 as a functional unit. The function of the notification unit 401 may be implemented by, for example, loading a program that is installed on an auxiliary storage device of the user terminal 40 to a memory device and executing the loaded program on a CPU.

The notification unit 401 notifies the presence of software update of the vehicle 10 to the user via the display device, based on the signal received from the distribution server 20. This allows the user of the vehicle 10 to be aware of the presence of software update of the vehicle 10 at the timing when the user is not using the vehicle 10. Accordingly, for example, the user can input software update permission on the user terminal 40, and complete the software update at the timing when the user is not using the vehicle 10.

Specific Examples of Method of Predicting Effect of Vehicle Software Update

Description is now given of specific examples of the method of predicting the effect of updating software of the vehicle 10 by the effect prediction unit 304 with reference to FIGS. 5 to 8.

### First Specific Example

FIG. 5 shows an example of the update of a shift map for a transmission of the vehicle 10. Specifically, FIG. 5 shows switching conditions between first gear and second gear, between second gear and third gear, and between third gear and fourth gear of the transmission of the vehicle 10 on a coordinate system with a horizontal axis being vehicle speed of the vehicle 10 and a vertical axis being required drive force of the vehicle 10.

Note that the required drive force of the vehicle 10 is determined, for example, in accordance with the accelerator operation amount by the driver of the vehicle 10. In FIG. 5, solid lines represent switching conditions (shift lines) during upshift, and dotted lines represent switching conditions (shift lines) during downshift.

As shown in FIG. 5, in this example, the switching condition between third gear and fourth gear is changed from shift lines 501 to shift lines 502 due to software update of the ECU 13 that controls the shift position of the transmission.

For example, consider the case where the user of the vehicle 10 uses an operating point 503 relatively frequently. Based on the shift lines 501, the transmission is maintained at third gear without the upshift from third gear to fourth gear in the state of the operating point 503. As a result, the rotation speed of the motor such as an engine or a motor generator is maintained at relatively high speeds. This results in a relatively high energy consumption in the vehicle 10. On the other hand, when the software update is performed, and the switching condition is updated to the shift lines 502, the upshift from third gear to fourth gear is completed, and the transmission is maintained at fourth gear, in the state of the operating point 503. As a result, the rotation speed of the motor such as an engine or a motor generator is maintained at relatively low speeds. This results in a relatively low energy consumption in the vehicle 10, so that fuel efficiency and electric power efficiency are improved. Therefore, the effect prediction unit 304 can predict that the software update has the effect of reducing energy consumption or that the degree of the effect is relatively high.

For example, consider the case where the user of the vehicle 10 relatively frequently uses an operating point 504 that is in the same vehicle speed range as the operating point 503 and that is lower in required drive force than the operating point 503. In this case, the upshift from third gear to fourth gear is completed and the transmission is maintained at fourth gear in the state of the operating point 504 regardless of the shift lines 501, 502. Therefore, the effect prediction unit 304 can predict that the software update has no effect or that the degree of the effect is relatively low. The same may apply to the case where, for example, the user of the vehicle 10 does not at all use a vehicle speed range 505 that is influenced by the change in switching conditions, or the case where the user uses the vehicle speed range 505 at a very low frequency.

Thus, in this example, the effect prediction unit 304 can predict the effect by updating the software (shift map) based on the vehicle data relating to the required drive force and vehicle speed sequentially uploaded from the vehicle 10.

Note that the effect prediction unit 304 may predict the effect of the software update relating to the switching condition of the shift change in the transmission, based on the result of a virtual simulation based on the virtual vehicle model of the vehicle 10. For example, the effect prediction unit 304 may predict the effect in terms of motive power performance of the vehicle 10 under the predetermined travel condition that is provided by the software update relating to the switching conditions of the shift change in the transmission, with use of a virtual simulation based on the virtual vehicle model of the vehicle 10.

### Second Specific Example

FIG. 6 shows an example of the update of a motor switching map of the vehicle 10. In this example, the vehicle 10 is a so-called hybrid electric vehicle capable of traveling by switching between two motors: an engine and a motor generator. Specifically, FIG. 6 shows a switching condition between the state in which the vehicle 10 travels with only the motor generator (MG) with the engine being stopped and the state in which the engine is started and the vehicle 10 travels with the engine, on the coordinate system with a horizontal axis being vehicle speed of the vehicle 10 and a vertical axis being required drive force of the vehicle 10.

Note that the state where the vehicle 10 travels with the engine may include both the state where the vehicle 10 travels with only the engine and the state where the vehicle 10 travels with both the engine and the motor generator.

As shown in FIG. 6, in this example, due to the software update in the ECU 13 that performs comprehensive control of the operating state of the two motors, a switching condition for switching between the state where the vehicle 10 travels with only the motor generator and the state where the vehicle 10 travels with the engine is updated from a switching line 601 (thin solid line) to a switching line 602 (thick solid line).

For example, consider the case where the user of the vehicle 10 uses an operating point 603 relatively frequently. Based on the switching line 601, in the state of the operating point 603, the engine is started and the vehicle 10 travels with the motive power of the engine. Meanwhile, when the software update is performed and the switching condition is updated to the switching line 602, the vehicle 10 can travel with only the motive power of the motor generator in the state of the operating point 603. As a result, the fuel efficiency of the vehicle 10 is improved. Therefore, the effect prediction unit 304 can predict that the software update has the effect of improving fuel efficiency of the vehicle 10 or that the degree of the effect is relatively high.

For example, consider the case where the user of the vehicle 10 relatively frequently uses an operating point 604 that is in the same vehicle speed range as the operating point 603 and that is lower in required drive force than the operating point 603. In this case, the vehicle 10 travels with only the motive power of the motor generator in the state of the operating point 604, regardless of the switching lines 601, 602. Therefore, the effect prediction unit 304 can predict that the software update has no effect of improving the fuel efficiency of the vehicle 10 or that the degree of the effect is relatively low. The same may apply to the case where, for example, the user of the vehicle 10 does not at all use an operating region 605 that is influenced by the change in switching condition or the case where the user uses the operating region 605 at a very low frequency.

Thus, in this example, the effect prediction unit 304 can predict the effect by updating the software (motor switching map) based on the vehicle data relating to the required drive force and vehicle speed sequentially uploaded from the vehicle 10.

### Third Specific Example

FIG. 7 shows an example (time chart 700) of the results of a virtual simulation regarding secular change of the state of the vehicle 10 during shift change of the transmission before and after update of a control logic relating to shift change (upshift) of the transmission of the vehicle 10. Specifically, FIG. 7 shows the results of the virtual simulation based on a virtual vehicle model dedicated to one vehicle 10 included in the software update system 1. The time chart 700 includes time charts 701 to 704 representing respective secular changes in release pressure command value, engagement pressure command value, rotation speed of motor (engine), and longitudinal acceleration of the vehicle 10 during shift change of the transmission. FIG. 8 shows another example (time chart 800) of the results of a virtual simulation regarding secular change in the state of the vehicle 10 during shift change of the transmission before and after the update of a control logic relating to shift change (upshift) of the transmission of the vehicle 10. Specifically, FIG. 8 shows the results of the virtual simulation based on a virtual vehicle model dedicated to the other vehicle 10 mounted with a transmission identical in specifications to the one vehicle 10 included in the software update system 1. The time chart 800 includes time charts 801 to 804 representing respective secular changes in release pressure command value, engagement pressure command value, rotation speed of an output shaft of the transmission, and longitudinal acceleration of the vehicle 10 during shift change of the transmission.

Here, the release pressure command value represents a hydraulic pressure command value for actuating the component members (e.g., brakes, clutches, etc.) of the transmission that shifts from an engaged state to a released state by the shift change. The engagement pressure command value represents a hydraulic pressure command value for actuating the component members of the transmission that shifts from the released state to the engaged state by the shift change. In FIGS. 7 and 8, the control logics for shift change of the transmission before and after the update are the same. Therefore, the time charts 701, 702 and the time charts 801, 802, which correspond to the control logic, are identical.

As shown in FIGS. 7 and 8, in this example, the control logic for the shift change of the transmission is updated so as to reduce the time (shifting time) from the start of shift change (upshift) (the start of reducing the release pressure command value) to the end of shift change (the end of increasing the engagement pressure command value).

In the time chart 703, a changing speed (rate of change over time) in rotation speed of the motor (engine) due to the shift change of the transmission is relatively high due to the update of the control logic. In the time chart 704, a fluctuation in longitudinal acceleration of the vehicle 10 with the shift of the transmission is also relatively large. Therefore, the user can clearly sense an increase in speed of shift change (shifting speed). Therefore, in the case of the one vehicle 10 of FIG. 7, the effect prediction unit 304 can predict that the software update has the effect of improving the shifting speed or that the degree of the effect is relatively high.

Meanwhile, in the time chart 803, the change speed (rate of change over time) in rotation speed of the motor (engine) due to the shift change of the transmission does not substantially change before and after the update of the control logic. In the time chart 804, there is little change in the magnitude of the fluctuation in longitudinal acceleration of the vehicle 10 due to shift change of the transmission before and after the control logic is updated. Therefore, it is not easy for the user to sense the improved shift change speed (shifting speed). Therefore, in the case of the other vehicle 10 of FIG. 8, the effect prediction unit 304 can predict that the software update has no effect of improving the shifting speed or that the degree of the effect is relatively low.

Here, it may be considered that the effect by updating the control logic differs depending on the vehicles 10 that are mounted with the transmission having the same specifications due to, for example, the influence of viscosity of the lubricants used in the transmission. For example, when commercial lubricants that are more viscous than the lubricants that are filled at shipment from factory are used in the transmission, it may be difficult for the user to sense the improved shifting speed. It may also be considered that the effect of updating the control logic differs depending on the vehicles 10 that are mounted with the transmission having the same specifications due to, for example, variations in the manufacturing of clutch pack clearance of the transmission. For example, when the clutch pack clearance of the transmission is close to a lower limit within manufacturing tolerances, it may be more difficult for the user to sense the improvement in the shifting speed than when the clutch pack clearance is close to an upper limit. It may also be considered that the effect of updating the control logic differs depending on the vehicles 10 that are mounted with the transmission having the same specifications due to, for example, the influence of the accumulated number of shifting in the transmission. For example, when the accumulated number of shifting after the vehicle 10 is shipped from factory or after the transmission is replaced with a new product is relatively small, the clutch pack clearance of the transmission may be relatively smaller than when the accumulated number of shifting is large, which may make it difficult for the user to sense the improved shifting speed. It may also be considered that the effect of updating the control logic differs depending on the vehicles 10 that are mounted with the transmission having the same specifications due to, for example, the influence of an air leak in solenoid valves that engage and release the clutch and brake of the transmission. For example, when the air leak in the solenoid valves of the transmission is relatively small, the shifting speed is relatively higher than when the air leak is relatively large. Hence, it may be difficult for the user to sense the improved shifting speed even when the control logic is updated. It may also be considered that the effect of updating the control logic differs depending on the vehicles 10 that are mounted with the transmission having the same specifications due to, for example, the influence of temperature environments where the vehicle 10 is used. For example, when the vehicle 10 is used in so-called cold climate where the temperature is very low, the lubricating oil has a higher viscosity than when the vehicle 10 is used in relatively high temperatures. Hence, it may be difficult for the user to sense the improved shifting speed even when the control logic is updated.

Thus, in this example, the effect prediction unit 304 can predict the effect of updating the software (program relating to the control logic for the shift change of the transmission) based on the results of the virtual simulation regarding shift change of the transmission based on the virtual vehicle model.

In this example, the effect prediction unit 304 can also cause the simulator unit 303 to perform a virtual simulation regarding the vehicle 10 after software update with use of the virtual vehicle model dedicated to the vehicle 10. Therefore, the effect prediction unit 304 can more accurately predict the effect of software update in matching with specific circumstances of each vehicle 10, such as the secular change of the vehicle 10, the change in use condition of the vehicle 10, and the change in component members of the vehicle 10.

Software Update Processing

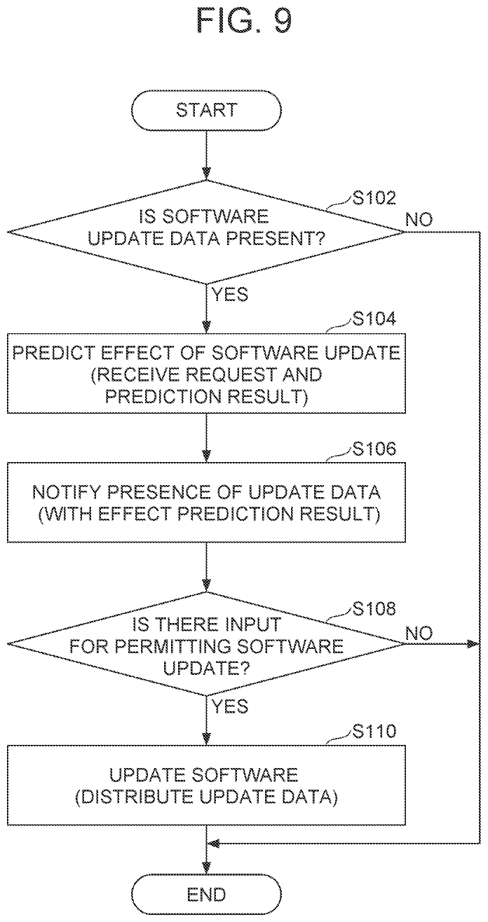

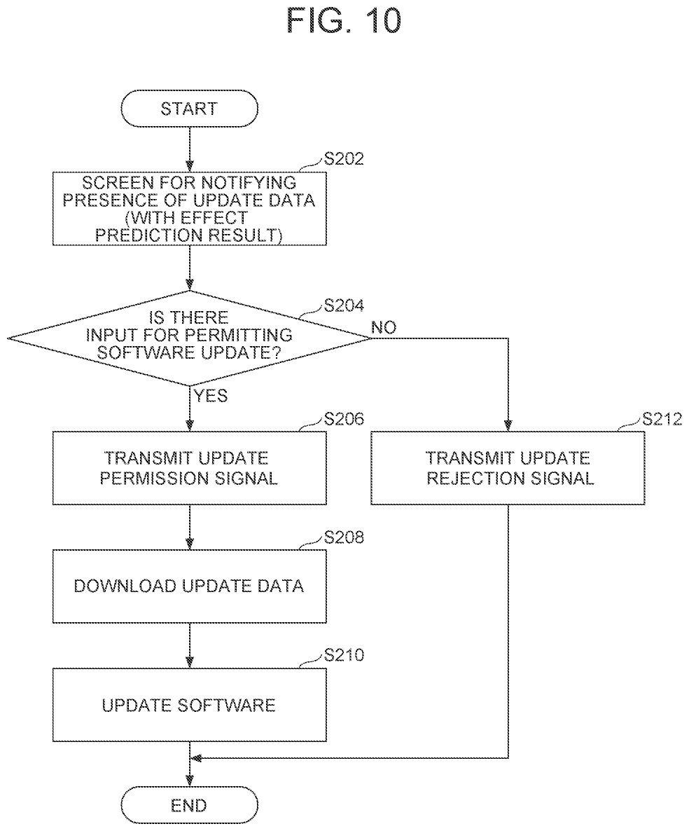

Description is now given of the processing for updating software (hereinafter “software update processing”) of the vehicle 10 with reference to FIGS. 9 and 10.

FIG. 9 is a flowchart schematically showing an example of software update processing by the distribution server 20. FIG. 10 is a flowchart schematically showing an example of software update processing by the central ECU 19.

The flowchart in FIG. 9 is repeatedly executed at each predetermined period, for example. The flowchart in FIG. 10 is executed when a notification indicating the presence of software update is received from the distribution server 20.

As shown in FIG. 9, in step S102, the notification unit 201 determines whether or not software update data for the vehicle 10 is present, that is, whether or not new update data is registered, to be specific. When the software update data for the vehicle 10 is present, the notification unit 201 proceeds to step S104. When the software update data for the vehicle 10 is not present, the notification unit 201 ends this flowchart.

In step S104, the notification unit 201 requests the analysis server 30 to predict the effect of the software update of the vehicle 10, and receives the predicted result from the analysis server 30.

When the processing of step S104 is completed, the distribution server 20 proceeds to step S106.

In step S106, the notification unit 201 transmits a notification signal indicating the presence of update data including the result of predicting the effect of the software update to the vehicle 10 that is a distribution target of the update data.

When the processing of step S106 is completed, the distribution server 20 proceeds to step S108.

In step S106, the notification unit 201 may transmit the notification signal to the user terminal 40 of the user of the vehicle 10 in place of or in addition to the vehicle 10.

When the signal transmitted in the processing of step S106 is received, the central ECU 19 of the vehicle 10 starts the flowchart in FIG. 10.

In step S202, the download processing unit 192 (an example of the notification unit) displays on the display device 18 a screen for notifying the presence of software update data, including the result of predicting the effect of the software update. This allows the user of the vehicle 10 to determine whether or not to perform software update in consideration of the effect obtained from the software update.

When the processing of step S202 is completed, and an input regarding permission or rejection of the software update is accepted via the input device 17, the central ECU 19 proceeds to step S204.

In step S204, the download processing unit 192 determines whether or not the input for permitting the software updates is accepted. When the input for permitting the software update is accepted, the download processing unit 192 proceeds to step S206. When the input for permitting the software update is not accepted, i.e., when the input for rejecting the software update is accepted, the download processing unit 192 proceeds to step S212.

In step S206, the download processing unit 192 transmits a signal for permitting the software update (hereinafter “update permission signal”) to the distribution server 20 via the gateway ECU 12 (communication device 11).

When the processing of step S206 is completed, the central ECU 19 proceeds to step S208.

As shown in FIG. 9, in step S108, the notification unit 201 determines whether or not the input for permitting the software updates is accepted in the vehicle 10. Specifically, the notification unit 201 determines whether or not the update permission signal is received from the vehicle 10 that is a distribution target of the update data. When the update permission signal is received from the vehicle 10, the notification unit 201 proceeds to step S110.

In step S110, the distribution unit 202 (an example of the update unit) distributes the update data to the vehicle 10, and causes the vehicle 10 (central ECU 19) to perform the software update.

When the processing of step S110 is completed, the distribution server 20 ends this flowchart processing.

As shown in FIG. 10, in step S208, the download processing unit 192 downloads the updated data distributed from the distribution server 20 through the gateway ECU 12 (communication device 11).

When the processing of step S208 is completed, the central ECU 19 proceeds to step S210.

In step S210, the software update unit 194 uses the update data downloaded to the storage unit 193 to perform software update in response to a software update command received from the distribution server 20.

Here, the software update unit 194 (an example of the update unit) may determine by itself to perform the software update upon completion of the download of the update data from the distribution server 20.

When the processing of step S210 is completed, the central ECU 19 ends this flowchart processing.

Meanwhile, in step S212, the download processing unit 192 transmits a signal for rejecting the software update (hereinafter “update rejection signal”) to the distribution server 20 via the gateway ECU 12 (communication device 11).

When the processing of step S212 is completed, the central ECU 19 ends this flowchart processing.

Here, when the distribution server 20 transmits the notification signal indicating the presence of update data to the user terminal 40 as described above, the user terminal 40 (notification unit 401) executes the processing similar to the flowchart of FIG. 10 except the processing of steps S208, S210. When the user terminal 40 transmits the update permission signal to the distribution server 20, the central ECU 19 executes only the processing of steps S208, S210 in the flowchart of FIG. 10 in response to a command from the distribution server 20.

As shown in FIG. 9, when the update permission signal is not received from the vehicle 10, that is, when the update rejection signal is received from the vehicle 10 in step S108, the notification unit 201 ends this flowchart processing.

Thus, in this example, the software update system 1 can notify the presence of the software update data to the user, along with the effect of the software update, and perform the software update of the vehicle 10 after confirming the permission from the user.

Note that the update data may be distributed to the vehicle 10 before user permission or rejection of the software update is confirmed. When the data on the effect is prepared in advance for the software update as described above, the update data and the data on the effect may be distributed in advance before user permission or rejection of the software update is confirmed. In this case, when download of the update data is completed, the central ECU 19 (an example of the information processing device) may notify the presence of the update data to the user, along with the result of predicting the effect of the software update and the data on the effect prepared in advance, through the display device 18.

Operation

Description is now given of the operation of the software update system 1 according to the present embodiment.

In the present embodiment, the software update system 1 updates software used in the vehicle 10 based on update data of the software, the update data being transmitted to the vehicle 10 from an external device that is communicably connected to the vehicle 10. Specifically, the software update system 1 includes a notification unit (e.g., the download processing unit 192 and the notification unit 201) and an update unit (e.g., the software update unit 194). The notification unit notifies, when the software update data is present, the presence of the update data to a user of the vehicle 10, along with information about an effect provided by the software update based on the update data. The update unit updates the software based on the update data, when a predetermined input is accepted from the user after the notification by the notification unit, that is, when an input for permitting the software update is accepted, to be specific.

This enables the software update system 1 to allow the user of the vehicle 10 to confirm the effect of the software update, and to update the software of the vehicle 10 under the agreement of the user made by a predetermined input. Accordingly, it is possible to prevent the situation where, for example, the user is waiting for software update to be completed, and the software update is implemented but the effect of the software update is small enough to disappoint the user, so that the time of the user is wasted. Therefore, the software update system 1 can enhance the user convenience in update of the software used in the vehicle 10.

In the present embodiment, the software update system 1 may include a prediction unit (e.g., the effect prediction unit 304). Specifically, when the software update data is present, the prediction unit may predict the effect obtained by updating the software. The notification unit may notify the presence of the update data to the user of the vehicle 10, along with information about the result of prediction by the prediction unit.

This allows the software update system 1 to notify a specific effect obtained by the software update to the user of the vehicle 10.

In the present embodiment, the prediction unit may predict the effect obtained by software update by performing a virtual simulation using a virtual vehicle model corresponding to the vehicle 10.

This allows the software update system 1 to accurately predict the effect of the software update.

In the present embodiment, the prediction unit may predict the effect obtained by software update by comparing actual data on the vehicle 10 and data obtained by the virtual simulation based on the virtual vehicle model corresponding to the vehicle 10 that is in the state after the software update based on the update data.

Accordingly, the software update system 1 can predict the effect of the software update in a simple way by using the actual data on the existing vehicle 10.

In the present embodiment, the prediction unit may predict the effect obtained by software update by comparing data obtained by the virtual simulation based on the virtual vehicle model corresponding to the vehicle 10 before and after software update based on the update data.

This allows the software update system 1 to more accurately predict the effect of the software update.

In the present embodiment, the prediction unit may determine whether or not to perform virtual simulation in prediction of the effect, in accordance with the content of the software update based on update data.

Accordingly, the software update system 1 can balance between, for example, simplified processing for predicting the effect of the software update and the accuracy of predicting the effect of the software update. As a result, processing efficiency can be enhanced.

In the present embodiment, the prediction unit may change the travel condition of the vehicle 10 during the virtual simulation in accordance with the content of the software update based on update data.

This allows the software update system 1 to perform the virtual simulation in matching with the travel condition that is influenced by the software update. Accordingly, the software update system 1 can more accurately predict the effect of the software update.

In the present embodiment, the virtual vehicle model may also be a general-purpose model corresponding to the vehicle 10.

As a result, the software update system 1 can predict the effect of software update by using, for example, a virtual vehicle model (general-purpose model) common to the vehicles 10 identical in vehicle type. Therefore, the software update system 1 can reduce the effort and time required to prepare the virtual vehicle model for evaluating the effect of software update, which allows more efficient prediction of the effect of the software update, for example.

In the present embodiment, the virtual vehicle model may also be a dedicated model corresponding to the vehicle 10.

As a result, the software update system 1 can predict the effect of the software update by using a virtual vehicle model dedicated to each of the vehicles 10. Therefore, the software update system 1 can reflect the unique circumstances of the individual vehicles 10 upon the effect of the software update, and as a result, can more accurately predict the effect of the software update.

In the present embodiment, the software update system 1 may also include a generation unit (e.g., the virtual vehicle model acquisition unit 301) that generates the virtual vehicle model. The generation unit may update the virtual vehicle model in matching with at least one of secular change of the vehicle 10, change in use condition of the vehicle 10, and change in component members of the vehicle 10.

Accordingly, the software update system 1 can reflect the specific unique circumstances of the vehicle 10, such as the secular change of the vehicle 10, the use condition of the vehicle 10, and the change in component members of the vehicle 10, upon the virtual vehicle model dedicated to the vehicle 10.

In the present embodiment, the generation unit may acquire data representing an actual state of the vehicle 10, and generate and update a digital twin of the vehicle 10 as the virtual vehicle model.

As a result, the software update system 1 can predict the effect of the software update by using the virtual vehicle model (digital twin) that constantly reflects the latest state of the vehicle 10. This allows the software update system 1 to more accurately predict the effect obtained by the software update.

In the present embodiment, the prediction unit may also predict the effect obtained by the software update in consideration of the period of time the user uses the vehicle 10 in the future.

This allows the software update system 1 to notify an effect obtained by the software update to the user in consideration of the circumstances of the users. Therefore, the software update system 1 can help the user to more easily make a decision at the time of determining whether or not to perform the software update.

Although the embodiments have been described in detail, the present disclosure is not limited to such specific embodiments. Various modifications and changes may be possible without departing from the scope of the present disclosure as set forth by the appended claims.

What is claimed is:

1. An information processing system configured to update software used in a vehicle based on update data of the software, the update data being transmitted to the vehicle from an external device that is communicably connected to the vehicle, the information processing system comprising:
a notification unit configured to notify, when the update data is present, the presence of the update data to a user of the vehicle, along with information about an effect provided by the software update based on the update data; and
an update unit configured to update the software based on the update data, when a predetermined input is accepted from the user after the notification by the notification unit.

2. The information processing system according to claim 1, comprising a prediction unit configured to predict the effect, when the update data is present,
wherein the notification unit notifies the presence of the update data to the user of the vehicle, along with information about a result of prediction by the prediction unit.

3. The information processing system according to claim 2, wherein the prediction unit predicts the effect by performing a virtual simulation using a virtual model corresponding to the vehicle.

4. The information processing system according to claim 3, wherein the prediction unit predicts the effect by comparing actual data on the vehicle and data obtained by the virtual simulation based on the virtual model corresponding to the vehicle that is in a state after the software update based on the update data.

5. The information processing system according to claim 3, wherein the prediction unit predicts the effect by comparing respective pieces of data obtained by the virtual simulation based on the virtual model corresponding to the vehicle before the software update and the vehicle after the software update based on the update data.

6. The information processing system according to claim 3, wherein the prediction unit determines whether or not to perform the virtual simulation in prediction of the effect, in accordance with a content of the software update based on the update data.

7. The information processing system according to claim 3, wherein the prediction unit changes a travel condition of the vehicle in the virtual simulation, in accordance with a content of the software update based on the update data.

8. The information processing system according to claim 3, wherein the virtual model is a general-purpose model corresponding to the vehicle.

9. The information processing system according to claim 3, wherein the virtual model is a dedicated model corresponding to the vehicle.

10. The information processing system according to claim 9, comprising a generation unit configured to generate the virtual model,
wherein the generation unit updates the virtual model in matching with at least one of secular change of the vehicle, change in use condition of the vehicle, and change in component members of the vehicle.

11. The information processing system according to claim 10, wherein the generation unit acquires data representing a real state of the vehicle, and generates and updates a digital twin of the vehicle as the virtual model.

12. The information processing system according to claim 2, wherein the prediction unit predicts the effect in consideration of a period of time that the user uses the vehicle in future.

13. An information processing device configured to update software used in a vehicle based on update data of the software, the update data being transmitted to the vehicle from an external device that is communicably connected to the vehicle, the information processing device comprising:
a notification unit configured to notify, when the update data is present, the presence of the update data to a user of the vehicle along with information about an effect provided by the software update based on the update data; and
an update unit configured to update the software based on the update data, when a predetermined input is accepted from the user after notification by the notification unit.

14. An information processing method executed by an information processing device configured to update software used in a vehicle based on update data of the software, the update data being transmitted to the vehicle from an external device that is communicably connected to the vehicle, the information processing method comprising:
a notification step of notifying, when the update data is present, the presence of the update data to a user of the vehicle, along with information about an effect provided by the software update based on the update data; and
an update step of updating the software based on the update data, when a predetermined input is accepted from the user after the notification in the notification step.

15. A program for causing an information processing device to execute steps, the information processing device being configured to update software used in a vehicle based on update data of the software, the update data being transmitted to the vehicle from an external device that is communicably connected to the vehicle, the steps comprising:
a notification step of notifying, when the update data is present, the presence of the update data to a user of the vehicle, along with information about an effect provided by the software update based on the update data; and
an update step of updating the software based on the update data, when a predetermined input is accepted from the user after the notification in the notification step.

16. A computer-readable recording medium configured to record the program according to claim 15.
